(19) United States
(12) Patent Application Publication
(10) Pub. No.: US 2006/0063541 A1
(43) Pub. Date: Mar. 23, 2006

(54) Apparatus and method for canceling SMS message transmission and retaining received SMS message

(75) Inventor: Hye-Hun Ryu, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/227,627

(22) Filed: Sep. 15, 2005

(30) Foreign Application Priority Data
Sep. 20, 2004 (KR) 2004-0074998

(51) Int. Cl. H04Q 7/20

(52) U.S. Cl. 455/466; 455/403

(57) ABSTRACT

Provided is an apparatus and method for cancellation of an SMS message transmission and for retainment of a received SMS message, which can prevent an undesired transmission of an SMS message and an undesired deletion of a received SMS message. A method for cancellation of a message transmission in a mobile communication terminal includes the steps of transmitting a message at a transmitting terminal, and transmitting a transmitted message-cancellation command at the transmitting terminal. An undesired transmission of a message can be prevented, and a received message can also be prevented from being deleted irrespective of a user's intention.

### PRIORITY

This application claims priority under 35 U.S.C. § 119 to an application entitled “Apparatus and Method for Cancellation of SMS Message Transmission and Retaining of Received SMS Message” filed in the Korean Intellectual Property Office on Sep. 20, 2004 and assigned Serial No. 2004-74998, the contents of which are incorporated herein by reference.

### BACKGROUND OF THE INVENTION

1. Field of the Invention

The present invention relates to a mobile communication terminal capable of transmitting and receiving an SMS message, and more particularly, to an apparatus and method for cancellation of an SMS message transmission and for retainment of a received SMS message, which can prevent an undesired transmission of an SMS message and a undesired deletion of a received SMS message.

2. Background of the Prior Art

The code division multiple access (CDMA) mobile telephone system has attracted worldwide attention for its various advantages such as a large system capacity, an interference prevention function and a superior voice quality. CDMA mobile telephones have been commercialized and have been used by many subscribers in Korea and around the world. CDMA mobile communication service providers are developing various supplementary services.

A short message service (SMS) is easily realized by its inherent data transmission function in the CDMA communication system. The SMS has a two-way paging function and thus enables various services such as a simple character message-transmitting/receiving service and a voice mailbox service.

In the SMS, a mobile communication system and a mobile communication terminal communicate with each other by using a data burst message defined in the IS-95-A standard. The data burst message may have different lengths according to system requirements, but is considerably restricted in its length. Specifically, the length of a receiving data burst message is limited up to about 150 bytes, and the length of a transmitting data burst message is limited up to about 100 bytes.

The SMS is very similar to a two-way paging service, and can be classified into a one-way communication service such as a voice mailbox-informing function and a simple message-transmitting/receiving function, and a two-way communication service such as an information-on-demand service.

For SMS, a specific status word (S/W) for SMS is applied to a mobile communication terminal. A message center (MC) and a network protocol for processing the SMS are needed in a mobile communication system.

The network protocol is defined in the TIA/EIA/IS-637 standard and TSB 79 standard. SMS is initiated by pressing a predetermined means such as a hot key (which usually has a letter envelope-shaped pattern) or a specific menu button of a mobile communication terminal.

SMS can also be classified as a point-to-point service allowing confirmation of transmission and a cell broadcasting service providing a one-way broadcast. The point-to-point service requires confirmation of a transmission result related to a specific terminal, and thus performs in nearly the same way as the two-way paging service.

On the contrary, the cell broadcasting service does not require confirmation of a transmission result to a specific terminal, and thus is similar in operation to the one-way paging service.

Therefore, the point-to-point service cannot be performed when a terminal is turned off or is in a reception-impossible zone.

For point-to-point service, an MC temporarily stores a message received from a transmitting terminal, and then forwards the stored message to a receiving terminal when the receiving terminal can receive messages. Consequently, the point-to-point service cannot guarantee real-time communication of messages.

The cell broadcasting service is similar to the one-way paging service, wherein a cell broadcasting service system transmits messages generally by using a paging channel defined in the IS-95-A standard. The cell broadcasting service system informs a terminal of a slot at which a message is transmitted, and the terminal transmits a message at a corresponding time slot.

The cell broadcasting service does not retransmit a message to a terminal even if the terminal did not receive a message from the terminal at a corresponding time slot. When a user's terminal is under call, the cell broadcasting service system transmits a message to the user's terminal over a traffic channel.

FIG. 1A is a diagram illustrating the conventional message receiving procedure in a mobile communication terminal.

A message receiving service is a basic SMS. The message receiving service includes a voice mailbox-informing service and a simple message-receiving service. Only when a message has been accurately transmitted to a user's terminal in a point-to-point transmission, does the MC complete the transmission of the message.

Referring to FIG. 1A, when a user presses a message receive hot key of a mobile communication terminal so as to receive an SMS message, an SMS message receive menu is displayed on a screen of the terminal. The SMS message receive menu can also be selected at an initial display screen of the terminal. After selecting a ‘1. RECEIVE MESSAGE’ item from the SMS message transmit/receive menu, the user can select a desired service.

As described previously, the message receiving service includes a voice mailbox-informing service and a simple message-receiving service. A mobile communication terminal receives an SMS message and then transmits a reception completion-informing response to a base station. SMS messages can be received repeatedly at the terminal due to adverse communication conditions.

This is because a mobile communication system retransmits the SMS message to the terminal when the system does not receive the reception completion-informing response from the terminal within a predetermined time after transmission of the SMS message. The repeated SMS messages can be generated up to a maximum of 20 times.

An SMS protocol inherently has a call back number function by which a called user can directly call back a calling user. Accordingly, when a calling user stores a voice message in a voice mailbox and then leaves a call back number, a called user can call the calling user by directly pressing a send key of a called terminal.

FIG. 1B illustrates the conventional message transmitting procedure in a mobile communication terminal. A message transmitting function enables a calling user to transmit a simple message to a called mobile terminal and a called pager.

Referring to FIG. 1B, when a user presses a message transmit hot key of a mobile terminal so as to transmit an SMS message, an SMS message transmit menu is displayed on a screen of the mobile terminal. The SMS message transmit menu can also be selected at an initial display screen of the terminal. After selecting a ‘2. TRANSMIT MESSAGE’ item from the SMS message transmit menu, the user can select a desired service. A transmission message can be written in English and Korean, and is transmitted in selected language.

FIG. 2 illustrates a message processing procedure according to the conventional message transmitting procedure.

Referring to FIG. 2, for an SMS message transmission, a transmitting terminal 10 primarily transmits an SMS message to an MC 12 of a CDMA network. The MC 12 may be a base station handling transmission/reception of an SMS message. Upon receiving the SMS message from the transmitting terminal 10, the MC 12 transmits a response message indicating reception of the SMS message to the transmitting terminal 10.

The MC 12 stores or forwards the received SMS message depending on whether or not a receiving terminal 11 can receive the SMS message. That is, if the receiving terminal 11 cannot receive the SMS message, the MC 12 stores the SMS message without forwarding the SMS message to the receiving terminal 11. Otherwise, if the receiving terminal 11 can receive the SMS message, the MC 12 forwards the SMS message to the receiving terminal 11.

Referring back to FIG. 1A, upon reception of the SMS message from the MC 12, the receiving terminal 11 transmits a response indicating reception of the SMS message to the MC 12. A receiving user having received the SMS message can select a desired service from an SMS message transmit/receive menu of the receiving terminal 11.

However, in the conventional message transmitting/receiving method, once a transmitting user presses a send confirmation button of a transmitting terminal for an SMS message transmission, the user cannot cancel the SMS message transmission. Consequently, despite a situation where a transmitting user transmits an SMS message by mistakenly pressing a receiving user's telephone number and then desires to cancel the mistaken SMS message transmission, the transmitting user cannot cancel the mistaken SMS message transmission.

The conventional method and apparatus also lack the capability to prevent a received SMS message from being undesirably deleted irrespective of the user's intention.

### SUMMARY OF THE INVENTION

The present invention provides an apparatus and method for canceling an SMS message transmission to prevent an undesired transmission of an SMS message and for retaining a received SMS message in a mobile communication terminal, to prevent the received SMS message from being undesirably deleted, irrespective of a user's intention.

According to an aspect of the present invention, a method for cancellation of an outgoing message transmission in a mobile communication terminal, includes the steps of transmitting an outgoing message at a transmitting terminal; and transmitting an outgoing message-cancellation command at the transmitting terminal.

The transmitting terminal may receive a message reception completion-indicating response from an MC having received the outgoing message, after the transmission of the outgoing message.

The step of transmitting the outgoing message-cancellation command may further include the step of transmitting the outgoing message-cancellation command from the transmitting terminal to the MC when the transmitting terminal's user selects a transmission cancellation menu, and deleting the outgoing message stored in the MC when the transmitted message has not yet been transmitted from the MC to a receiving terminal.

The MC may transmit a message cancel completion-indicating response to the transmitting terminal when the stored outgoing message is successfully deleted. The MC may transmit an outgoing message-cancellation command to the receiving terminal if the transmitted message has been already transmitted to the receiving terminal. The outgoing message may be an SMS (short message service) message, or a voice message.

According to another aspect of the present invention, a mobile communication terminal capable of canceling an outgoing message transmission, includes a display unit for displaying status information generated during the operation of the mobile communication terminal and a message transmit menu; a controller for executing an outgoing message-transmitting command and an outgoing message-cancellation command according to a selection of the message transmit menu; and a keypad for selecting the message transmit menu displayed on the display unit and transmitting selected key input data to the controller.

The controller may receive an outgoing message reception success-indicating response from an MC having received an outgoing message. The MC may delete a stored outgoing message according to the outgoing message-cancellation command from the mobile communication terminal if the outgoing message has been not yet transmitted to a receiving terminal.

According to a further another aspect of the present invention, a method for retaining a received outgoing message in a mobile communication terminal, includes the steps of receiving an outgoing message from a transmitting terminal at a receiving terminal; and receiving a received outgoing message-cancellation command at the receiving terminal.

The receiving terminal may transmit a message reception success-indicating response to an MC upon reception of the outgoing message.

If the receiving terminal's user beforehand sets a received message cancellation-preventing function at the receiving terminal, the receiving terminal may transmit a received outgoing message cancellation failure-indicating response to the MC upon reception of the received outgoing message-cancellation command. If the receiving terminal's user does not beforehand set a received message cancellation-preventing function at the receiving terminal, the receiving terminal may delete the received outgoing message according to the received outgoing message-cancellation command.

If the receiving terminal's user has already opened the received outgoing message, the receiving terminal may transmit a received outgoing message cancellation failure-indicating response to the MC upon reception of the received outgoing message-cancellation command irrespective of whether the receiving terminal's user beforehand sets a received message cancellation-preventing function at the receiving terminal.

The receiving terminal may transmit a response indicating completion of execution of the received outgoing message-cancellation command to the MC after deleting the received outgoing message according to the received outgoing message-cancellation command.

The outgoing message may be an SMS message, or a voice message.

According to still another aspect of the present invention, a mobile communication terminal capable of preventing a random deletion of a received message, includes a display unit for displaying status information generated during the operation of the mobile communication terminal and a message transmit menu; a controller for receiving an outgoing message according to a selection of the message transmit menu and executing a received message random cancellation-preventing command according to a user's selection; and a keypad for selecting the message transmit menu displayed on the display unit and transmitting selected key input data to the controller.

The controller may transmit a message reception success-indicating response to an MC upon reception of a message.

The controller may transmit an outgoing message cancellation failure-indicating response to the MC if a transmitting terminal's user beforehand sets a received message deletion-preventing function at the transmitting terminal. The controller may delete a received message if the terminal's user does not set a received message deletion-preventing function at the terminal. If the terminal's user has already opened a received message, the controller may transmit a received outgoing message cancellation failure-indicating response to the MC irrespective of whether the terminal's user beforehand sets a received message cancellation-preventing function at the terminal.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1A illustrates the conventional message receiving procedure in a mobile communication terminal;

FIG. 1B illustrates the conventional message transmitting procedure in a mobile communication terminal;

FIG. 2 illustrates a message processing procedure according to the conventional message transmitting procedure;

FIG. 3 is a block diagram of a mobile communication terminal according to an embodiment of the present invention;

FIG. 4A illustrates a menu item for cancellation of an SMS message transmission according to an embodiment of the present invention;

FIG. 4B illustrates a menu item for retainment of a received SMS message according to an embodiment of the present invention;

FIG. 5 illustrates procedures for cancellation of an SMS message transmission and for retainment of a received SMS message according to an embodiment of the present invention; and

FIG. 6 flow diagrams procedures for cancellation of an SMS message transmission and for retainment of a received SMS message according to an embodiment of the present invention.

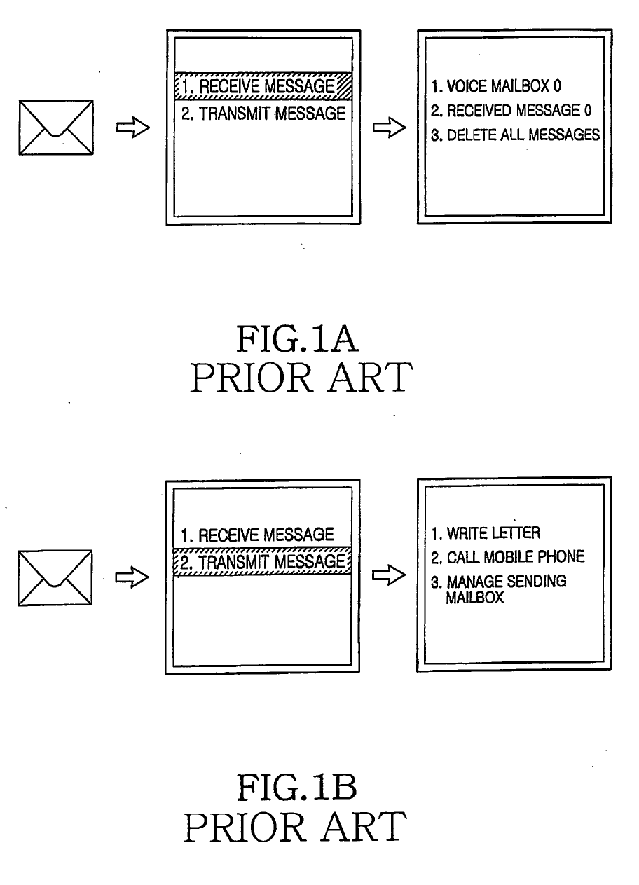

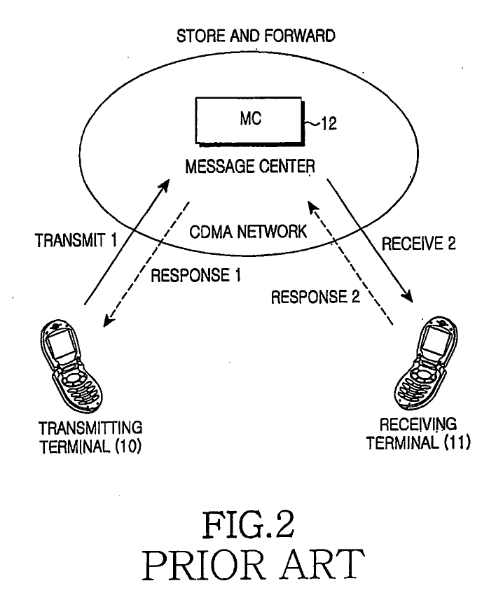

### DETAILED DESCRIPTION OF THE PREFERRED EMBODIMENTS

Reference will now be made in detail to the preferred embodiments of the present invention, examples of which are illustrated in the accompanying drawings. In the drawings, like reference numerals in the drawings denote like elements, and thus their description will be omitted. Also, when it is determined that the subject of the invention may be ambiguous by a detailed description of the related well-known functions and constructions, the detailed description will be omitted.

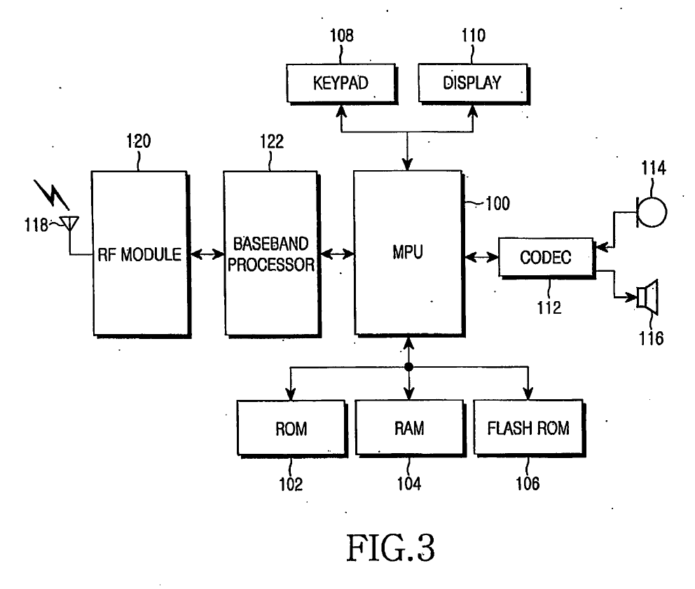

FIG. 3 is a block diagram of a mobile communication terminal according to an embodiment of the present invention.

A mobile communication terminal described below includes a cellular phone, a personal communication system (PCS) terminal, a personal data assistant (PDA), an international mobile communication 2000 (IMT-2000) terminal, etc. The following descriptions will be made with a general structure of the above terminals.

Referring to FIG. 3, a microprocessor unit (MPU) 100 controls an overall operation of a mobile communication terminal. For example, the MPU 100 processes and controls voice communication and data communication. In addition to the typical functions, the MPU 100 performs a command for cancellation of an outgoing message (an outgoing message-cancellation command) and a function for preventing the deletion of a received message (a received message deletion-preventing function). A description about the typical process and control operation of the MPU 100 will be omitted.

A read only memory (ROM) 102 stores a variety of reference data and microcodes of a program for the process and control operation of the MPU 100. The ROM 102 is a nonvolatile memory and thus can retain data regardless of the presence of a power supply.

A random access memory (RAM) 104 is a volatile memory and serves as a working memory of the MPU 100. The RAM 104 stores temporary data that are created during the execution of various programs.

A flash ROM 106 is a nonvolatile memory and acts as a database, like a phone book, storing various updateable data. The flash ROM 106 stores an SMS message according to the present invention and deletes a message retained therein according to a message deletion command received from the MPU 100.

A keypad 108 includes numeric keys of digits 0-9 and a plurality of function keys, such as a menu key, a cancellation (deletion) key, a confirmation key, a talk key, an end key, an Internet connection key, navigation keys (up/down/right/left), and so on. The keypad 108 provides key input data, corresponding to keys pressed by a user, to the MPU 100.

The four navigation keys are used as hot keys, which allow specific menu items (e.g., a message management (←), a phone book (→), a top-level menu list (↑) and a music box (↓)) to be directly entered. In general, the terminal has two keys (a menu key and a navigation key) for entering the top-level menu list.

A display unit 110 displays status information, characters of a predetermined length, a large quantity of moving pictures and still pictures, and so on. A color liquid crystal display (LCD) may be used as the display unit 110.

A coder-decoder (CODEC) 112 connected to the MPU 100, a speaker 116 and a microphone 114 connected to the CODEC 112 constitute an audio input/output block that is used for a telephone communication and voice recording. The MPU 100 produces pulse code modulation (PCM) data and the CODEC 112 converts the PCM data into analog audio signals. The analog audio signals are outputted through the speaker 116. Also, the CODEC 112 converts audio signals received through the microphone 114 into PCM data and provides the PCM data to the MPU 100.

A radio frequency (RF) module 120 down-converts a frequency of an RF signal received through an antenna 118 and provides the resulting baseband signal to a baseband processor 122. Also, the RF module 120 up-converts a frequency of a baseband signal provided from the baseband processor 122 and transmits the resulting baseband signal through the antenna 118. The baseband processor 122 processes the baseband signals that are exchanged between the RF module 120 and the MPU 100.

For example, in the case of the data transmission, the baseband processor 122 performs channel coding and spreading on the transmitting data. In the case of the data reception, the baseband processor 122 despreads and channel decodes the receiving data.

That is, the baseband processor 122 decodes a variety of channels (paging channel, traffic channel, etc.) that are received from a base station, or generates a variety of channels (access channel, traffic channels, etc.) that are to be transmitted to the base station.

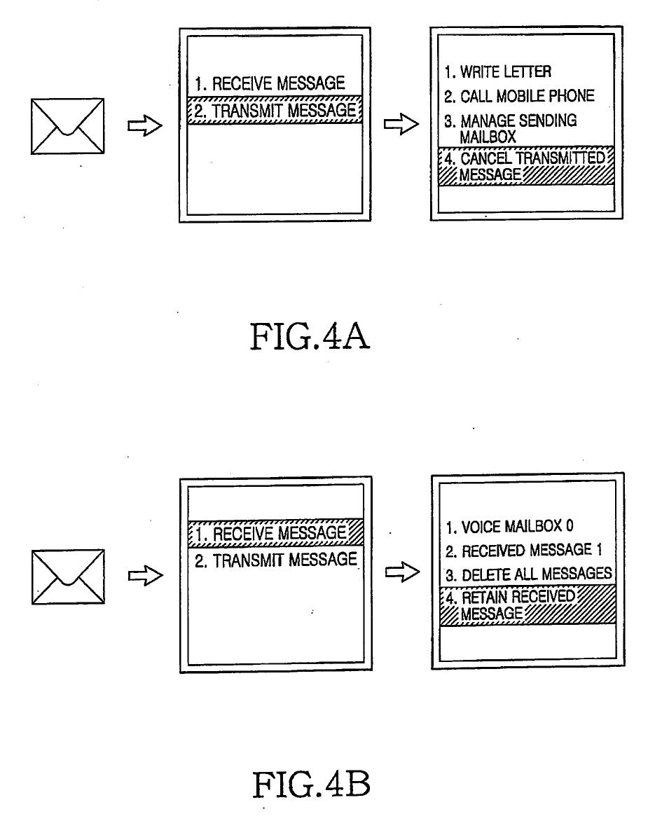

FIG. 4A illustrates a menu item for cancellation of an SMS message transmission according to an embodiment of the present invention. Referring to FIG. 4A, when a user who has mistakenly transmitted an SMS message presses a message transmit/receive hot key of a mobile communication terminal so as to cancel the mistaken SMS message transmission, an SMS message transmit/receive menu is displayed on a screen of the terminal. The SMS message transmit/receive menu can also be selected at an initial screen of the terminal.

The user selects a ‘2. TRANSMIT MESSAGE’ menu item from the displayed SMS message transmit/receive menu and then selects a ‘4. CANCEL TRANSMITTED MESSAGE’ menu item out of the resulting displayed menu. A transmitted message-cancellation function activated by the selection of the CANCEL TRANSMITTED MESSAGE menu item can be used, for example, when a receiving user's telephone number is mistakenly input or when an SMS message transmission itself is desired to be canceled.

In another situation, sometimes a receiving user having received an SMS message does not desire the received message to be deleted. That is, the user desires to confirm all the received SMS messages.

FIG. 4B illustrates a menu item for retaining a received SMS message according to an embodiment of the present invention. The present invention provides a function that allows a user to prevent a unwanted deletion of received messages when he desires to confirm all the received messages. As shown in FIG. 4B, when a user desires to confirm all the messages transmitted will not deleted, the user can utilize a previously-set function for preventing unwanted deletion of received messages. Referring to FIG. 4B, when a user presses the message transmit/receive hot key of the mobile communication terminal, the SMS message transmit/receive menu is displayed on the screen of the terminal. The SMS message transmit/receive menu can also be selected at an initial screen of the terminal.

The user selects a ‘1. RECEIVE MESSAGE’ menu item among the displayed SMS message transmit/receive menu and then selects a ‘4. RETAIN RECEIVED MESSAGE’ menu item among the resulting displayed menu. The RETAIN RECEIVED MESSAGE menu item provides a received message unwanted deletion-preventing function.

The present invention can be applied to a voice message as well as the SMS message.

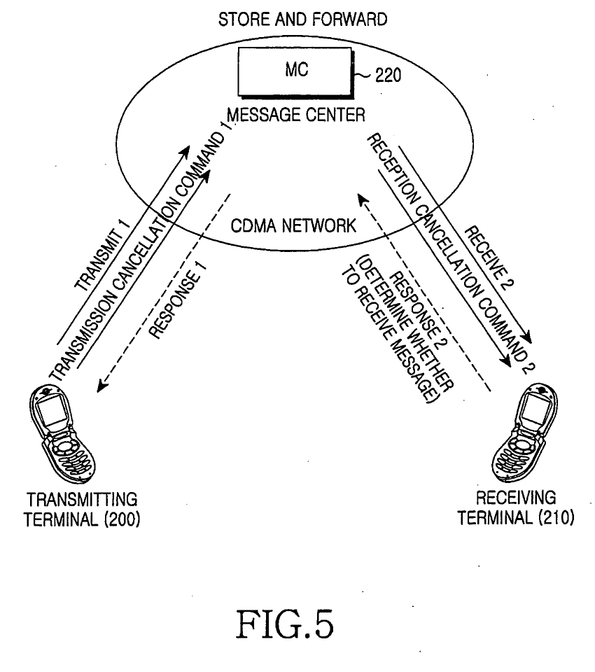

FIG. 5 illustrates procedures for cancellation of an SMS message transmission and for retainment of a received SMS message according to an embodiment of the present invention. Referring to FIG. 5, a transmitting terminal 200 primarily transmits an SMS message to a message center (MC) of the CDMA network. Upon receiving the SMS message from the transmitting terminal 200, the MC 220 transmits a response message indicating success of reception of the SMS message (hereinafter, simply referred to as “an SMS message reception success-indicating message”) to the transmitting terminal 200.

The MC 220 stores or forwards the received SMS message depending on whether or not a receiving terminal 210 can receive the SMS message. That is, if the receiving terminal 210 cannot receive the SMS message, the MC 220 stores the SMS message without forwarding the SMS message to the receiving terminal 210. If the receiving terminal 210 can receive the SMS message, the MC 220 forwards the SMS message to the receiving terminal 210. Upon receiving the SMS message from the MC 220, the receiving terminal 210 transmits a response indicating success of reception of the SMS message (hereinafter, simply referred to as “an SMS message reception success-indicating response”) to the MC 220.

If a transmitting user would like to cancel the transmitted SMS message after transmitting an SMS message, the user selects a CANCEL TRANSMITTED MESSAGE menu item at the transmitting terminal 200 as illustrated in FIG. 4A. The transmitting terminal 200 then transmits a command for cancellation of an SMS message transmission (hereinafter, simply referred to as “an SMS message transmission-cancellation command”) to the MC 220.

If the transmitted SMS message has not yet been forwarded to the receiving terminal 210, the MC 220 deletes the SMS message stored therein. If the transmitted SMS message has already been forwarded to the receiving terminal 210, the MC 220 transmits an SMS message transmission-cancellation command to the receiving terminal 210.

Upon receiving the SMS message transmission-cancellation command from the MC 220, the receiving terminal 210 determines whether to execute the SMS message transmission-cancellation command according to conditions. That is, if the receiving user does not beforehand select a RETAIN RECEIVED MESSAGE menu item at the receiving terminal 210, the receiving terminal 210 deletes the received SMS message according to the SMS message transmission-cancellation command. After deleting the received SMS message, the receiving terminal 210 transmits a response indicating completion of a cancellation of SMS message transmission (hereinafter, simply referred to as “an SMS message transmission cancel completion-indicating response”) to the MC 220 so as to allow the transmitting terminal 200 to confirm that the SMS message transmission is successfully canceled.

If the receiving user has previously selected the RETAIN RECEIVED MESSAGE menu item for preventing a unwanted deletion of received SMS messages, the receiving terminal 210 transmits a response indicating failure of the SMS message transmission cancellation (hereinafter, simply referred to as “an SMS message transmission cancellation failure-indicating response”) to the MC 220.

If the receiving user has already opened and confirmed the received SMS message, the SMS message transmission cancellation is impossible irrespective of whether or not the RETAIN RECEIVED MESSAGE menu item is previously selected. Accordingly, if the receiving user has already opened and confirmed the received SMS message, the receiving terminal 210 having received the SMS message transmission-cancellation command from the MC 220 transmits the SMS message transmission cancellation failure-indicating response to the MC 220.

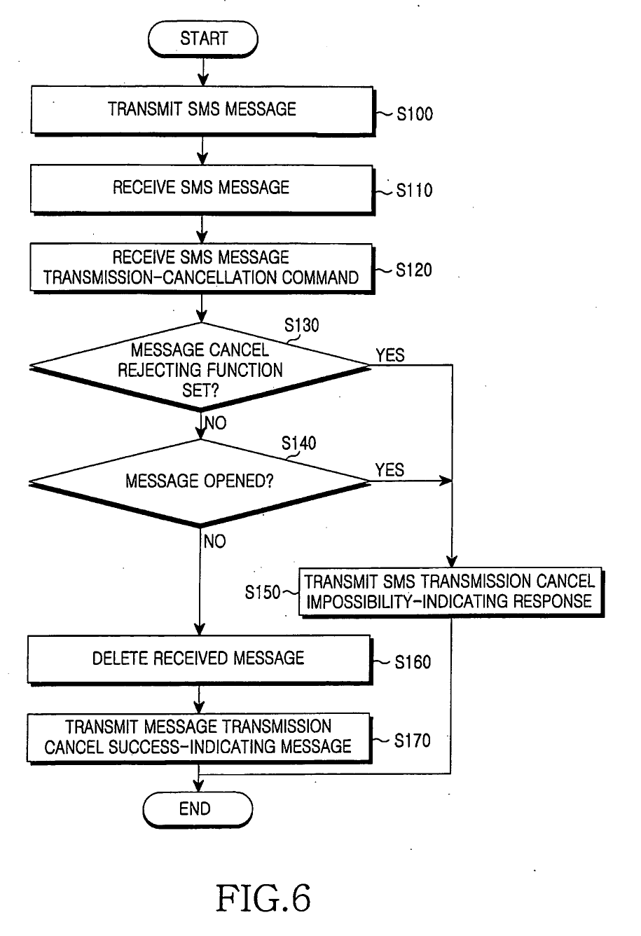

FIG. 6 is a flow diagram illustrating procedures for cancellation of an SMS message transmission and for retainment of a received SMS message according to an embodiment of the present invention. Referring to FIGS. 5 and 6, when a transmitting terminal 200 transmits an SMS message (S100), the SMS message is transmitted to an MC 220. Upon receiving the SMS message from the transmitting terminal 200, the MC 220 stores or forwards the received SMS message depending on whether or not a receiving terminal 210 can receive the SMS message.

That is, if the receiving terminal 210 cannot receive the SMS message, the MC 220 stores the SMS message without forwarding the SMS message to the receiving terminal 210. If the receiving terminal can receive the SMS message, the MC 220 forwards the SMS message to the receiving terminal 210. Upon receiving the SMS message from the MC 220, the receiving terminal 210 transmits an SMS message reception success-indicating response to the MC 220 to thereby complete normal reception of the transmitted SMS message (step S110).

If a transmitting user desires to cancel the transmitted SMS message after transmitting the SMS message, the transmitting user selects a CANCEL TRANSMITTED MESSAGE menu item at the transmitting terminal 200 as described. The transmitting terminal 200 then transmits an SMS message transmission-cancellation command to the MC 220. If the transmitted SMS message has not yet been forwarded to the receiving terminal 210, the MC 220 deletes the SMS message stored therein. If the stored SMS message is successfully deleted, the MC 220 transmits a response indicating completion of deletion of the stored SMS message to the transmitting terminal 200.

If the transmitted SMS message has already been forwarded to the receiving terminal 210, the MC 220 transmits an SMS message transmission-cancellation command to the receiving terminal 210. Upon receiving the SMS message transmission-cancellation command from the MC 220, the receiving terminal 210 determines whether to execute the SMS message transmission-cancellation command according to conditions (step S120).

That is, the receiving terminal 210 determines whether the receiving user has previously selected a RETAIN RECEIVED MESSAGE menu item, and then determines whether to execute the SMS message transmission-cancellation command according to the receiving user's selection of the RETAIN RECEIVED MESSAGE menu item (step S130). If the receiving user has previously selected the RETAIN RECEIVED MESSAGE menu item for preventing a random deletion of received SMS messages, the receiving terminal 210 transmits an SMS message transmission cancellation failure-indicating response to the MC 220 (step S150). If the receiving user has already opened and confirmed the received SMS message, the SMS message transmission cancellation becomes impossible irrespective of whether or not the RETAIN RECEIVED MESSAGE menu item has previously been selected (step S140).

Accordingly, if the receiving user has already opened and confirmed the received SMS message, the receiving terminal 210 having received the SMS message transmission-cancellation command from the MC 220 transmits the SMS message transmission cancellation failure-indicating response to the MC 220 (step S150).

If the receiving user has not selected the RETAIN RECEIVED MESSAGE menu item and has not opened the received SMS message, the receiving terminal 210 deletes the received SMS message according to the SMS message transmission-cancellation command received from the MC 220 (step S160). After deleting the received SMS message, the receiving terminal 210 transmits an SMS message transmission cancellation success-indicating message to the MC 220 so as to allow the transmitting terminal 200 to ascertain whether or not the SMS message transmission is successfully canceled (step S170).

The present invention can also be applied to a voice message as well as the SMS message.

As described above, the present invention not only can prevent an undesired transmission of a message but also can prevent a received message from being deleted contrary to the user's intention.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method for cancellation of a message transmission in a mobile terminal, comprising the steps of:
transmitting an outgoing message by the mobile terminal; and
transmitting an outgoing message-cancellation command by the mobile terminal.

2. The method of claim 1, wherein the step of transmitting the outgoing message by the mobile terminal further comprises receiving a message reception completion-indicating response from a message center (MC) having received the outgoing message.

3. The method of claim 1, wherein the step of the transmitting the outgoing message-cancellation command further comprises
deleting the outgoing message stored in a message center (MC) when the outgoing message has not yet been transmitted from the MC to a receiving terminal.

4. The method of claim 3, wherein the step of deleting the outgoing message further comprises transmitting a message cancel completion-indicating response by the MC to the mobile terminal when the stored outgoing message is successfully deleted.

5. The method of claim 3, wherein the step of transmitting the outgoing message-cancellation command further comprises transmitting an outgoing message-cancellation command by the MC to a receiving terminal if the outgoing message has been already transmitted to the receiving terminal.

6. The method of claim 1, wherein the outgoing message is an SMS (short message service) message.

7. The method of claim 1, wherein the outgoing message is a voice message.

8. A mobile communication terminal capable of canceling an outgoing message transmission, the mobile communication terminal comprising:
a display unit for displaying status information generated during the operation of the mobile communication terminal and a message transmit menu;
a controller for executing an outgoing message-transmitting command and an outgoing message-cancellation command according to a selection of the message transmit menu; and
a keypad for selecting the message transmit menu displayed on the display unit and transmitting selected key input data to the controller.

9. The mobile communication terminal of claim 8, wherein the controller receives an outgoing message reception success-indicating response from an MC (message center) having received an outgoing message.

10. The mobile communication terminal of claim 9, wherein the MC deletes a stored outgoing message according to the outgoing message-cancellation command from the mobile communication terminal if the outgoing message has not yet been transmitted to a receiving terminal.

11. A method for retaining a received outgoing message in a mobile terminal, comprising the steps of:
receiving an outgoing message from a transmitting terminal by the mobile terminal; and
receiving a received outgoing message-cancellation command by the mobile terminal.

12. The method of claim 11, wherein the step of receiving an outgoing message further comprises transmitting a message reception success-indicating response by the mobile terminal to a message center (MC) upon receiving the outgoing message.

13. The method of claim 11, wherein the step of receiving an outgoing message further comprises transmitting a received outgoing message cancellation failure-indicating response to the MC upon receiving the received outgoing message-cancellation command if a received message cancellation-preventing function menu is selected by the mobile terminal.

14. The method of claim 11, wherein the step of receiving an outgoing message further comprises deleting the received outgoing message according to the received outgoing message-cancellation command if a received message cancellation-preventing function menu is not selected by the mobile terminal.

15. The method of claim 11, wherein the step of receiving an outgoing message further comprises transmitting a received outgoing message cancellation failure-indicating response to the MC upon receiving the received outgoing message-cancellation command if the received outgoing message has already been opened.

16. The method of claim 11, wherein the outgoing message is one of an short message service (SMS) message and a voice message.

17. A mobile communication terminal capable of preventing a unwanted deletion of a received message, the mobile communication terminal comprising:
a display unit for displaying status information generated during the operation of the mobile communication terminal and a message transmit menu;
a controller for receiving an outgoing message according to a selection of the message transmit menu and executing a received message cancellation-preventing command according to a user's selection; and
a keypad for selecting the message transmit menu displayed on the display unit and transmitting selected key input data to the controller.

18. The mobile communication terminal of claim 17, wherein the controller transmits a message reception success-indicating response to an MC (message center) upon reception of a message.

19. The mobile communication terminal of claim 17, wherein the controller transmits an outgoing message cancellation failure-indicating response to the MC if a terminal's user beforehand sets a received message deletion-preventing function at the terminal.

20. The mobile communication terminal of claim 17, wherein the controller deletes a received message following receipt of an outgoing message cancellation command, if the terminal's user does not set a received message deletion-preventing function at the terminal.
